(19) United States
(12) Patent Application Publication
(10) Pub. No.: US 2026/0158359 A1
(43) Pub. Date: Jun. 11, 2026

(54) VIRTUAL GOLF SIMULATION APPARATUS AND KEYPAD APPARATUS USED THEREFOR

(71) Applicant: GOLFZON CO., LTD., Seoul (KR)

(72) Inventors: Su Gyum KIM, Daejeon (KR); Hyun Kag KANG, Daejeon (KR)

(73) Assignee: GOLFZON CO., LTD., Seoul (KR)

(21) Appl. No.: 18/707,162

(22) PCT Filed: Nov. 3, 2022
(86) PCT No.: PCT/KR2022/017083

§ 371 Date: May 2, 2024

(30) Foreign Application Priority Data
Nov. 5, 2021 (KR) 10-2021-0151209

(51) Int. Cl. A63B 71/06; A63B 69/36; A63B 102/32; G06F 3/01; G06F 3/02

(52) U.S. Cl. CPC A63B 71/0619; A63B 69/36; G06F 3/016; G06F 3/0219; A63B 2102/32

(57) ABSTRACT

The present invention is to provide a virtual golf simulation apparatus and a keypad device used therefor that allow a user who stands on a swing stage for a golf shot to easily operate with a part of the user's body or a golf club held by the user to implement a function in a virtual golf simulation process, and improve the mechanical button pressing method of the conventional button manipulation device so that the functions of the virtual golf simulation apparatus can be operated simply and conveniently, and the reliability of the operation can be improved by transmitting the sense of operation according to the operation of the keypad to the user.

### TECHNICAL FIELD

The present invention is related to a virtual golf simulation apparatus and keypad apparatus used the virtual golf simulation apparatus, more specifically it is possible to promote the convenience of a user by allowing the user who plays a virtual golf play to easily operate a menu or specific content on the screen while standing on a swing stage for a golf swing.

### BACKGROUND ART

With the recent upsurge in the number of golfers, a so-called screen golf system, which enables a golfer to practice golf and to play a round of virtual golf using a virtual golf simulation apparatus, has gained popularity.

The screen golf system is a system that senses the velocity and direction of a golf ball that a golfer hits onto a screen installed indoors to display a virtual golf course and displays the progress of the golf ball on the screen.

The screen golf system enables a user to hit a golf ball by a golf swing and to feel the same realism that the user feels when playing a round of golf on an actual golf course.

In such a screen golf system, when a user stands on a swing stage to swing golf, a situation occurs in which specific information displaying on a screen must be manipulated. Conventionally, in such a situation, there was a problem that it was very cumbersome and inconvenient because the user had to leave the swing stage and move to a position where the manipulation unit was installed to perform the manipulation of specific information and then enter the swing stage again.

In order to solve this problem, a technology equipped with a button operation device with multiple operation buttons on or around the swing stage has emerged to enable manipulation to implement various functions executed in the virtual golf simulation process.

As prior arts related to this, Korean Patent No. KR10-0923069, Korean Patent No. KR10-1799920, and Korean Patent No. KR10-1824395 are disclosed.

In the prior arts as stated above, a button manipulation device having buttons for a directional control, a golf ball tee-up, a terrain grid view and a mulligan is installed around the user's swing stage, and the user standing on the swing stage can perform the desired function by pressing a specific button on the button manipulation device with his or her foot or golf club.

A mechanical button-pressing manipulation device was provided as described above to provide the user with a sense of manipulation because the user mainly uses his feet while wearing shoes or uses a golf club held by the user when the user performs an operation for performing a specific function at the swing stage.

However, in the process of virtual golf simulation, there was a problem in that the fatigue caused by the mechanical button pressing of the manipulation device increased and was inconvenient when the user used a golf club or foot to operate each time.

In addition, there are many and various functions that can be implemented by user manipulation in the virtual golf simulation process, while the button manipulation device as described above is provided around the swing stage, and because its size is limited and the number of buttons is limited, the functions that can be implemented with buttons are also limited. Therefore, in order to implement functions that cannot be executed through the button manipulation device, there was a problem that the user had no choice but to leave the swing stage and access the keyboard or manipulation panel of a computer to operate.

### DISCLOSURE

### Technical Problem

It is an object of the present invention to provide a virtual golf simulation apparatus and a keypad device used therefor that allow a user who stands on a swing stage for a golf shot to easily operate with a part of the user's body or a golf club held by the user to implement a function in a virtual golf simulation process, and improve the mechanical button pressing method of the conventional button manipulation device so that the functions of the virtual golf simulation apparatus can be operated simply and conveniently, and the reliability of the operation can be improved by transmitting the sense of operation according to the operation of the keypad to the user.

It is another object of the present invention to provide a virtual golf simulation apparatus and a keypad device used therefor that allow various and many functions to be implemented through the keypad device despite the limited number of keys provided by the keypad device, in order to solve the problem of the prior art in which there are many and various functions that may be implemented by a user's operation in the virtual golf simulation process, while the number of functions that may be implemented by a button in a manipulation device is limited. cl Technical Solution

In accordance with an aspect of the present invention, the above and other objects can be accomplished by the provision of a keypad device used in a virtual golf simulation apparatus comprising: a pad body providing a plurality of key operators each of which detects manipulation by a user's body part or a golf club and cause a haptic reaction; a pad cover couplable to an upper end of the pad body and providing a plurality of key indicators each of which is provided at a position corresponding to each of the key operators and displays a function of a corresponding key; and a controller that controls the key operator to generate a haptic response according to the user's operation with respect to the corresponding key indicator, and implements a function corresponding to the operated key indicator.

Preferably, each of the key operators includes: a sensing module configured to detect at least one of the proximity, contact, and pressing of the user's body part or golf club as the operation; and a vibration module that generates vibration for the haptic reaction as the sensing module detects the operation.

Preferably, each of the key operators includes a light emitting module that allows light to be emitted through each of the key indicators as the sensing module detects the operation.

Preferably, the sensing module includes a metal detection sensor that detects a metal material and transmits a sensing value according to a distance from the metal material to the controller, and the controller is configured to recognize the operation as the golf club head is close to or in contact with the key indicator within a predetermined distance according to the sensing value of the metal detection sensor.

Preferably, the sensing module includes a pressure sensor that transmits a sensing value according to the pressure of an object to the controller, and the controller is configured to recognize that the user's body part contacts or presses on the key indicator according to the sensing value of the pressure sensor as the operation.

Preferably, the sensing module includes a metal detection sensor that detects a metal material and transmits a sensing value according to a distance from the metal material to the controller, and a pressure sensor that transmits a sensing value according to the pressure of a non-metal object to the controller.

Preferably, the controller is configured to detect the operation of the key as the user operates on the corresponding key indicator, to calculate the time for the operation to be maintained, and to generate different preset key functions according to the calculated operation maintenance time.

In accordance with another aspect of the present invention, there is provided a keypad device used in a virtual golf simulation apparatus comprising: a plurality of keys classified according to functions provided by the virtual golf simulation apparatus; a sensing module provided for each of the keys to detect operation by a user's body part or a golf club; and a controller that recognizes a sensing value of the sensing module as the user's operation on the key, maintains the recognition of the sensing value of the sensing module until the user's operation is released, and generates a preset key function based on the maintained time.

Preferably, the sensing module is configured to include one or more sensors for detecting at least one of the proximity, contact, and pressing of the user's body part or golf club as the user's operation.

Preferably, the sensing module is configured to include a metal detection sensor that transmits a sensing value according to a distance from a metal material to the controller to detect that the golf club head is close to or in contact with the key indicator within a predetermined distance, and the controller is configured to maintain recognition of the sensing value of the metal detection sensor until the proximity or contact state of the golf club head is released, and to implement different key functions according to the range of the maintenance time.

Preferably, the sensing module is configured to include a pressure sensor that transmits a sensing value according to the pressure of an object to the controller to detect that the user's body part contacts or presses the key indicator, and the controller is configured to maintain recognition of the sensing value of the pressure sensor until the state of contact or pressing by the user's body part is released, and to implement different key functions according to the range of the maintenance time.

In accordance with another aspect of the present invention, there is provided a keypad device used in a virtual golf simulation apparatus comprising: a plurality of keys classified according to functions provided by the virtual golf simulation apparatus; a sensing module provided for each of the keys to detect operation by a user's body part or a golf club; and a controller that generates a preset function according to the order of the operation for two or more key combinations of the plurality of the keys.

Preferably, the sensing module is configured to detect the proximity or contact of the golf club head, and the controller is configured to detect an operation order for the key combination according to gesture of the golf club head by the proximity or contact to generate a preset function according to the gesture.

In accordance with another aspect of the present invention, there is provided a keypad device used in a virtual golf simulation apparatus comprising: a plurality of keys classified according to functions provided by the virtual golf simulation apparatus; a sensing module provided for each of the keys to detect operation by a user's body part or a golf club; and a controller that sets at least one key of the plurality of keys to implement a plurality of functions, recognizes the type of the user's operation detected by the sensing module, matches the corresponding function among the plurality of functions of the key for each type of the user's operation, and implements different functions for each type of the user's operation for the key.

Preferably, when the user's operation is detected for the key by the sensing module, the controller is configured to control to implement a function of the corresponding key corresponding to the detected user's operation when no other kind of subsequent operation for the key is detected for a preset time.

In accordance with another aspect of the present invention, there is provided a virtual golf simulation apparatus comprising: a simulator that implements a simulation image in which a virtual ball moves on a virtual golf course image based on sensing information on the movement of at least one of a golf ball and a golf club as a user takes a golf shot on a swing stage; an image output device that outputs the virtual golf course image and simulation image implemented by the simulator; and a keypad device that is provided on or adjacent to the swing stage so that the user operate to implement functions provided by the simulator, wherein the keypad device includes: a plurality of keys classified according to the functions provided by the simulator, a sensing module provided for each of the keys to detect an operation by a user's body part or golf club, and a controller that generates a preset function of the simulator based on an operation maintenance time until the operation on the key is performed and the operation on the key is released.

Preferably, at least on function generated according to the operation maintenance time in the keypad device is changed according to the progress of the virtual golf simulation on the virtual golf course.

### Advantageous Effects

The virtual golf simulation apparatus and a keypad device used therefor according to an embodiment of the present invention have an advantageous effect that the functions of the virtual golf simulation apparatus can be operated simply and conveniently so as to allow a user who stands on a swing stage for a golf shot to easily operate with a part of the user's body or a golf club held by the user to implement functions in a virtual golf simulation process, and the reliability of the operation can be improved by transmitting the sense of operation according to the operation of the keypad to the user.

The virtual golf simulation apparatus and a keypad device used therefor according to an embodiment of the present invention have another advantageous effect that the keypad device can implement various and many functions despite the limited number of keys provided by the keypad device with easily operation and user convenience.

### DESCRIPTION OF DRAWING

FIG. 1 shows an example in which a virtual golf simulation apparatus according to an embodiment of the present invention is applied to a screen golf system.

FIG. 2 shows an example of operating a keypad device used in a virtual golf simulation apparatus according to an embodiment of the present invention.

FIG. 3 shows an exploded view of the keypad device used in a virtual golf simulation apparatus according to an embodiment of the present invention.

FIG. 4 is a block diagram showing a control system of the keypad device.

FIG. 5 is a diagram for explaining a method of recognizing a sensing value by the controller according to an output of the sensing module in the keypad device used in the virtual golf simulation apparatus according to another embodiment of the present invention.

FIGS. 6 and 7 show a example of a method of operating the keypad device used in the virtual golf simulation apparatus according to another embodiment of the present invention.

FIG. 8 is a flowchart showing an example of a method of operating the keypad device used in the virtual golf simulation apparatus according to another embodiment of the present invention.

FIG. 9 shows an example of a method of operating the keypad device by a gesture in the virtual golf simulation apparatus according to another embodiment of the present invention.

FIG. 10 shows that functions executed by operations of the keypad device varies according to the progress of the virtual golf simulation.

### BEST MODEL

Specific details of the virtual golf simulation apparatus and the keypad device used therefor according to the present invention will be described in detail with reference to the drawings below.

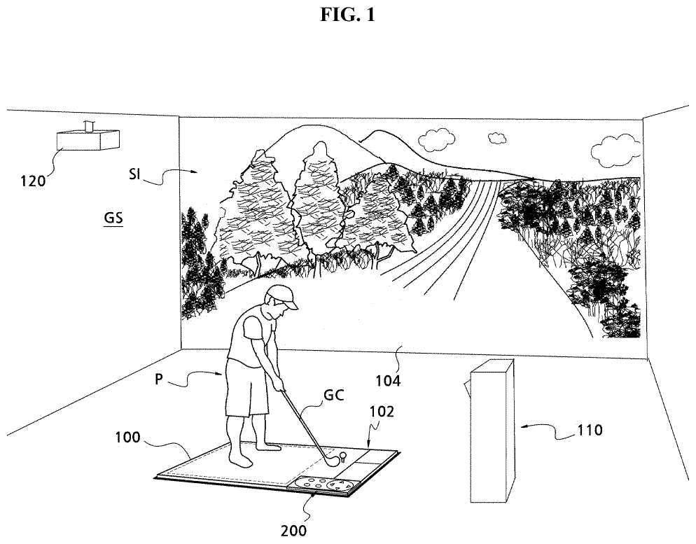

First, a virtual golf simulation apparatus according to an embodiment of the present invention will be described with reference to FIG. 1. FIG. 1 shows an example in which a virtual golf simulation apparatus according to an embodiment of the present invention is applied to a screen golf system.

A representative example to which the virtual golf simulation apparatus according to an embodiment of the present invention is applied is the screen golf system as shown in FIG. 1.

In the screen golf system as shown in FIG. 1, a swing stage 100 is installed in a golf space GS that provides a predetermined space for a user to play golf. When a screen 104 for projecting a virtual golf simulation image is installed in the front and the user P standing on the swing stage 100 hits a golf ball placed on a golf mat 102 toward the screen 104 in front with the golf club GC, a sensing device(not shown) senses the movement of the golf ball and the golf club, and based on the sensing result, a virtual golf simulation image is projected onto the screen 104 so that the user P may play as if the user P is actually playing golf on a virtual golf course provided as an image.

The virtual golf simulation apparatus according to an embodiment of the present invention may include a simulator 110 that implements a simulation image SI in which a virtual ball moves on a virtual golf course image based on sensing information on the movement of at least one of the golf ball or the golf club as the user P takes a golf shot on the swing stage 100, and an image output device 120 that outputs the virtual golf course image and simulation image SI implemented by the simulator 110.

In particular, the virtual golf simulation apparatus according to an embodiment of this invention includes a keypad device 200 that, as shown in FIG. 1, can be provided on or adjacent to the swing stage 100 so that the user standing on the swing stage can operate and can operate to implement functions provided by the simulator.

The keypad device 200 includes a plurality of keys classified according to functions provided by the simulator 110, and each key performs a preset function in the process of virtual golf simulation implemented by the simulator.

As shown in FIG. 1, the keypad device 200 may be provided on the swing stage 100 where the user P takes a golf shot or in a position where the user P may easily access the swing stage 100 so that the user P may easily operate it with his or her foot or club head.

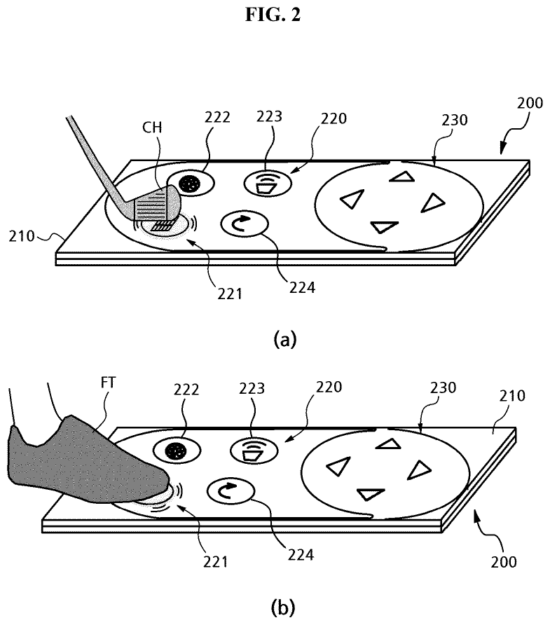

In FIG. 2, the keypad device 200 according to an embodiment of the present invention as described above is shown in more detail.

FIG. 2(a) shows a state in which the user operates a keypad device used in the virtual golf simulation apparatus according to an embodiment of the present invention using a golf club head, and FIG. 2(b) shows a user operating a key with his or her feet.

As shown in FIG. 2(a) and FIG. 2(b), the keypad device 200 used in the virtual golf simulation apparatus according to an embodiment of the present invention may include a body 210, function keys 220 for implementing various functions, and direction keys 230 for direction manipulation.

The function keys 220 may include a plurality of keys 221, 222, 223, and 224 for executing various functions (e.g., tee-up of a golf ball, topographic grid view, mulligan, etc.) that may be implemented in the course of the virtual golf simulation. For convenience, a key indicated by reference number 221 is referred to as a first key, a key indicated by reference number 222 is referred to as a second key, a key indicated by reference number 223 is referred to as a third key, and a key indicated by reference number 224 is referred to as a fourth key.

FIG. 2(a) and FIG. 2(b) show an example in which the function keys 220 are configured with four keys, but the present invention is not limited thereto, and may be configured with four or more keys to implement a predetermined function for each key.

The keypad device used in the virtual golf simulation apparatus according to an embodiment of this invention may be operated not by a mechanical button pressing method, but by a user's body part or the head of a golf club approaching the key within a predetermined distance, contacting the key, or applying a predetermined pressure (pressing) to the key. In addition, according to an operation (close, contact, or pressing by a user's body part or golf club) as described above, the keypad device may generate a haptic reaction to provide a sense of manipulation to the user.

In addition to the haptic reaction according to the operation described above, the user can improve the reliability of the manipulation by allowing the operated key to emit light to indicate that the operation has been performed.

In FIG. 2(a), as the user operates on the first key 221 with the club head CH, the first key 221 emits light and causes vibration to cause a haptic reaction. In FIG. 2(b), as the user operates on the first key 221 with his foot while wearing the shoe, the first key 221 emits light and generates vibration to cause a haptic reaction.

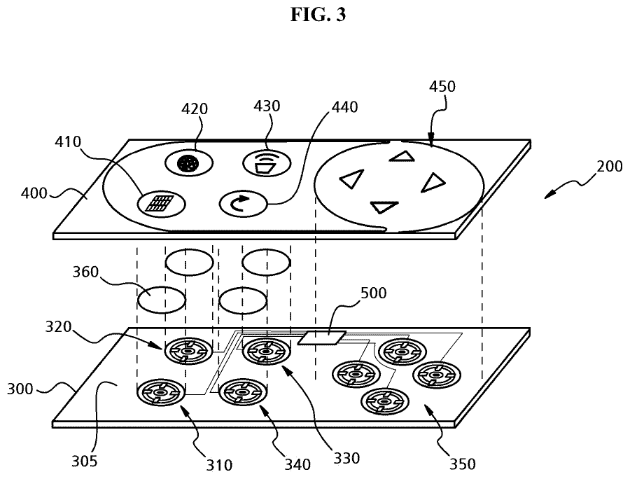

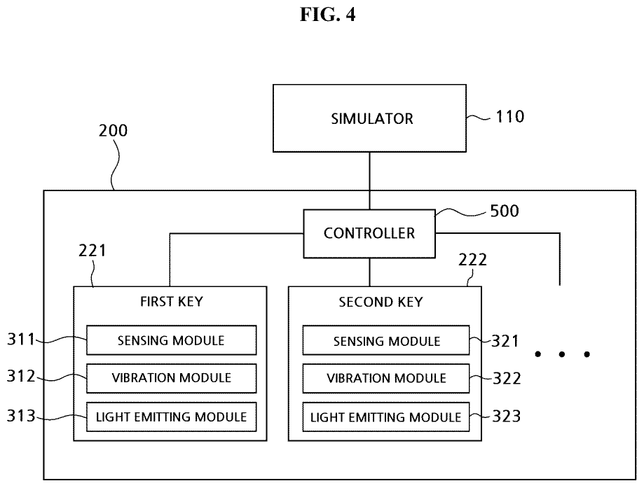

The configuration of the keypad device used in the virtual golf simulation apparatus according to an embodiment of the present invention as described above will be described in more detail with reference to FIGS. 3 and 4.

FIG. 3 shows an exploded view of the keypad device used in a virtual golf simulation apparatus according to an embodiment of the present invention, and FIG. 4 is a block diagram showing a control system of the keypad device.

The keypad device 200 used in the virtual golf simulation apparatus according to an embodiment of the present invention may include a pad body 300 equipped with various components for sensing operation, and a pad cover 400 covering the upper part of the pad body 300, as shown in FIG. 3.

The pad body 300 preferably includes a substrate 305 on which various components are embedded, and may include a plurality of key operators 310, 320, 330, and 340 corresponding to each key.

In addition, the pad cover 400 may include key indicators 410, 420, 430 and 440 coupled to the upper end of the pad body and displaying the function of the key at positions corresponding to the key operators 310, 320, 330 and 340, respectively.

In addition, at the top of each of the key operators 310, 320, 330 and 340, a key protection member 360 for protecting components is provided as shown in FIG. 3, so that damage to the key due to user operation may be prevented. The key protection member 360 may be made of a buffer material such as silicon.

A controller 500 may be provided in the pad body 300, and various sensors and modules in each of the key operators 310, 320, 330, and 340 provided in the pad body 300 may be connected to the controller 500 to operate under the control of the controller.

The controller 500 may control a haptic reaction of the key operator corresponding to the corresponding key indicator to occur as the user performs the above-described operation on the specific key indicator 410, 420, 430, or 440, and transmit key operation information corresponding to the corresponding key indicator to the simulator so that the simulator implements the function of the corresponding key.

In FIG. 3, the reference number 450 indicates the direction key indicator provided on the pad cover 400, and the reference number 350 indicates the direction key operator provided on the pad body 300 corresponding to each direction of the direction key indicator 450.

Various components for implementing and operating each key function may be provided in each of the plurality of key operators provided in the pad body 300. As shown in FIG. 4, each of the key operators may be provided with sensing modules 311, 321 . . . , vibration modules 312, 322 . . . , light emitting modules 313, 323 . . . , and the like, and the components may be connected to the controller 500 of the keypad device. The controller 500 is connected to the simulator 110 of the virtual golf simulation apparatus, and by transmitting operation information on each key of the keypad device to the simulator 110, the simulator 110 may implement a function corresponding to the key operated by the user.

The sensing module 311, 321 . . . provided in each of the keys 221, 222 . . . may be configured to detect at least one of proximity, contact, and pressing of the user's body part (refer to FIG. 2(b)) or a golf club (refer to FIG. 2(a)).

In addition, the vibration modules 312, 322 . . . provided in each key 221, 222 . . . generate vibrations for haptic reactions as the sensing module detects the user's operation, and the light emitting modules 313, 323 . . . emit light through the key indicator corresponding to the key, allowing the user to visually recognize that the key has been manipulated.

The sensing modules 311, 321 . . . may include a metal detection sensor that detects a metal material and transmits a sensing value according to a distance from the metal material to the controller 500. According to the sensing value of the metal detection sensor, the controller 500 may detect that the head of the golf club approaches or contacts the key indicator within a predetermined distance, and may recognize it as an operation.

Users standing on the swing stage tend to manipulate the key mainly using the head of the golf club. When the user approaches or contacts the club head to the desired key position, the internal metal detection sensor detects the club head made of a metal material, the vibration module generates vibration to cause a haptic reaction, and the light emitting module emits light, indicating that the key is operated. Accordingly, the function of the corresponding key by the controller may be implemented.

In addition, the sensing modules 311, 321 . . . may include a pressure sensor that transmits a sensing value according to the pressure of an object to the controller 500. The controller 500 may recognize the user's foot (shoe wearing state) as a manipulation when it contacts or presses the key indicator with a predetermined pressure according to the sensing value of the pressure sensor.

When the user standing on the swing stage places his or her foot on a desired key in the keypad device near the user, an internal pressure sensor may detect it, and the vibration module generates vibration to cause a haptic reaction, and at the same time, the light emitting module emits light, indicating that the key is operated. Accordingly, the function of the corresponding key by the controller may be implemented.

In addition, the sensing modules 311, 321 . . . may include both the metal detection sensor and the pressure sensor as described above, and accordingly, the controller 500 may recognize the proximity, contact, and pressing of both the user's body part and the golf club for a specific key according to the sensing value of the metal detection sensor and the sensing value of the pressure sensor.

Accordingly, while the user stands on the swing stage, by a simple operation of bringing the clubhead to a desired key position or putting the user's foot on the desired key position of the keypad device, the operation of the key for the simulator may be performed, and the keypad device may provide the user with the sense of manipulation through the haptic reaction by the vibration module and light emission.

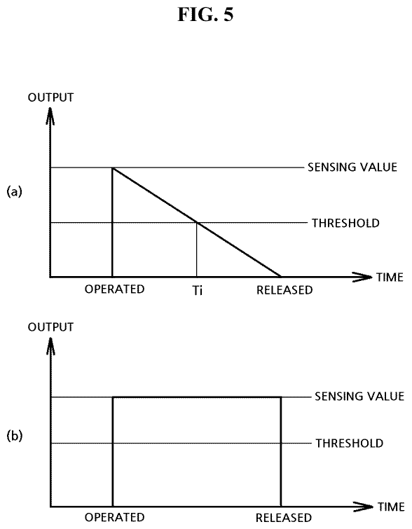

Meanwhile, a keypad device according to another embodiment of the present invention will be described with reference to FIGS. 5 to 7.

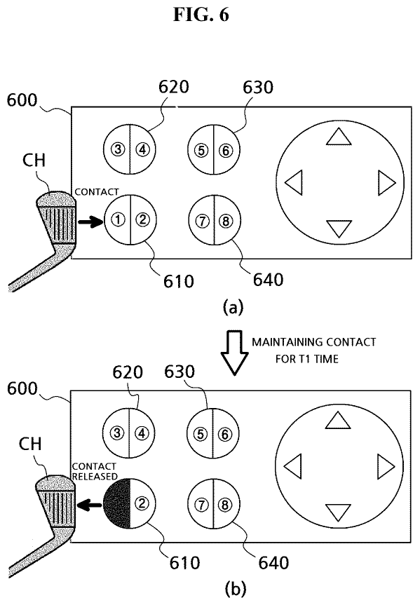

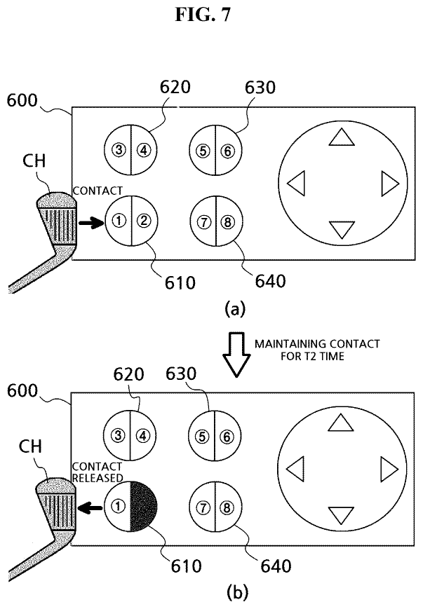

FIG. 5 is a diagram for explaining a method of recognizing a sensing value by the controller according to an output of the sensing module in the keypad device used in the virtual golf simulation apparatus according to another embodiment of the present invention, and FIGS. 6 and 7 show examples of a method of operating the keypad device used in the virtual golf simulation apparatus according to another embodiment of the present invention.

The sensing module provided inside each key of the keypad device generates a sensing value according to the user's operation (close, contact, or press by the user's body part or golf club) and transmits it to the controller, and the controller may recognize that the corresponding key has been operated when the sensing value exceeds a preset threshold.

For example, if the sensing module is the metal detection sensor, when the user approaches or contacts the club head with the first key position, the controller that receives the sensing value of the above metal detection sensor recognizes the proximity or contact of the club head as an operation for the first key and implements a function corresponding to the first key when the sensing value exceeds a preset threshold.

If the user positions the club head close to the first key (i.e., it is located at a distance less than the effective detection range of the metal detection sensor), the controller that receives the sensing value of the metal detection sensor does not recognize it as an operation for the first key because the sensing value does not exceed a preset threshold.

As described above, when the sensing value of the sensing module according to proximity, contact, or pressing by the user's body part or golf club exceeds the threshold value, the controller may recognize the corresponding action as an operation. Wherein the method in which the controller recognizes the operation may be a case in which it is recognized as a single manipulation regardless of whether the operation state is maintained as shown in FIG. 5(a), and another case in which it is recognized as operation continuously during the manipulation state is maintained and the sensing value is maintained until the manipulation is released as shown in FIG. 5(b).

In the former case, as shown in FIG. 5(a), if there is a key manipulation (e.g., contacting the clubhead with the key) and the controller recognizes a sensing value (the sensing value exceeding the threshold value), the controller's recognition of the sensing value is no longer maintained because the sensing value recognized by the controller falls below the threshold value over Ti time.

In the latter case, as shown in FIG. 5(b), if there is a key manipulation (e.g., contacting the clubhead with the key) and the controller recognizes a sensing value (the sensing value exceeding the threshold value), the controller can set the recognized sensing value to remain the same until the manipulation is released (e.g., removing the clubhead in contact with the key).

When the controller sets the recognition of the sensing value to be maintained as shown in FIG. 5(b), the time during which the state of the key manipulation is maintained may be included in the key manipulating operation.

For example, a time for maintaining the manipulation state may be calculated so that different key functions may be implemented according to the time.

In the keypad device used in the virtual golf simulation apparatus according to another embodiment of the present invention, as shown in FIG. 5(b), the controller recognizes a sensing value of the sensing module as the user manipulates the key, and the controller maintains recognition of the sensing value of the sensing module until the manipulation state is released and implements various key functions based on the maintained time.

FIGS. 6 and 7 show an example of a case in which the controller of the keypad device sets the recognized sensing value to be maintained as shown in FIG. 5(b), thereby enabling various operations.

As shown in FIG. 6(a), the keypad device 600 used in the virtual golf simulation apparatus according to another embodiment of the present invention includes a plurality of keys 610, 620, 630, and 640, and each key may be configured to execute two or more functions.

As shown in FIG. 6(a), the first key 610 may be configured to execute function \textcircled{1} and function \textcircled{2}, the second key 620 may be configured to execute function \textcircled{3} and function \textcircled{4}, the third key 630 may be configured to execute function \textcircled{5} and function \textcircled{6}, and the fourth key 640 may be configured to execute function \textcircled{7} and function \textcircled{8}.

Wherein each of the above functions represents a different function, for example, the function \textcircled{1} may be set to execute a terrain preview function and the function \textcircled{2} may be set to execute a mulligan function.

As described above, the controller of the keypad device 600 used in the virtual golf simulation apparatus according to another embodiment of the present invention detects a manipulation of a specific key as the user operates(for example, contacting the club head with the key) on the key indicator of the specific key, calculates the time for which the operation is maintained, and implements different preset key functions according to the calculated operation maintenance time.

For example, if it is predetermined that the function \textcircled{1} is activated when the operation maintenance time is T1 and the function \textcircled{2} is activated when the operation maintenance time is T2 in the first key 610, as the user contacts the club head CH with the first key 610 as shown in FIG. 6(a), the controller recognizes the manipulation, maintains the contact for T1 time, and then releases the contact of the club head CH as shown in FIG. 6(b), the controller can recognize the contact maintenance time of the club head as T1 time and activate function \textcircled{1} of the first key 610.

Also, as the user contacts the club head CH with the first key 610 as shown in FIG. 7(a), the controller recognizes the manipulation, maintains the contact for T2 time, and then releases the contact of the club head CH as shown in FIG. 7(b), the controller can recognize the contact maintenance time of the club head as T2 time and activate function \textcircled{2} of the first key 610.

In this way, by presetting the operation maintenance time for activation of each of the plurality of functions assigned to each of the keys, various and many functions may be implemented through the keypad device despite the limited number of keys provided by the keypad device.

If the sensing module is configured to include a metal detection sensor that transmits a sensing value according to a distance from a metal material to the controller to detect that the club head approaches or contacts the key within a predetermined distance, the controller may maintain recognition of the sensing value of the metal detection sensor until the proximity or contact state of the club head is released, and implement different functions depending on the range of the maintenance time.

If the sensing module is configured to includes a pressure sensor that transmits a sensing value according to a pressure of an object to the controller to detect that a part of the user's body contacts or presses on the key, the controller may maintain recognition of the sensing value of the pressure sensor until the state of contact or pressing by the part of the user's body is released, and implement different functions depending on the range of the maintenance time.

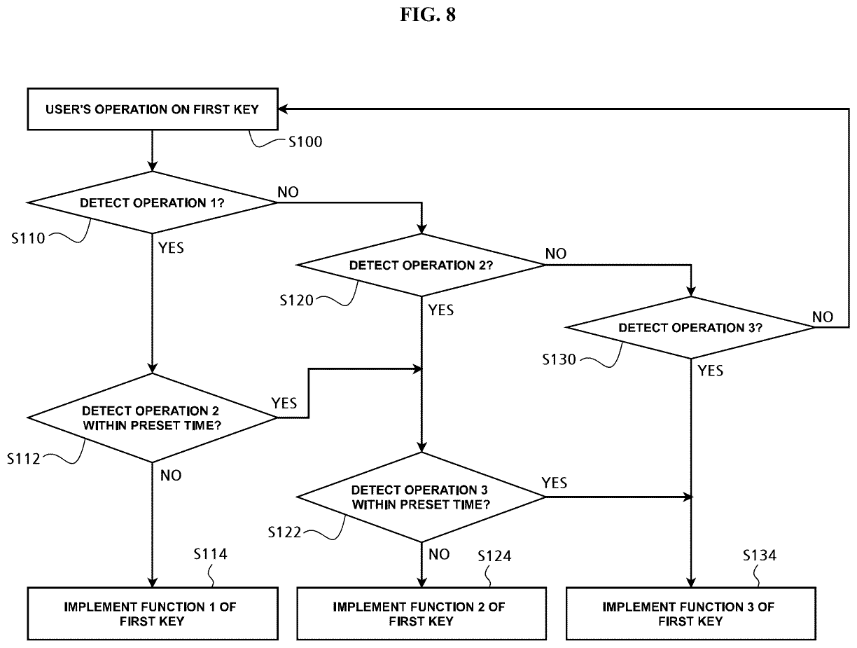

Meanwhile, the keypad device used in the virtual golf simulation apparatus according to another embodiment of the present invention will be described with reference to FIG. 8.

The keypad device according to the present embodiment also relates to a case in which each key may perform a plurality of functions as shown in FIG. 6(a) described above.

The embodiment shown in FIGS. 6 and 7 has shown a case in which a plurality of functions are set to be implemented for one key and different functions are implemented according to the maintenance time of the user's operation for the same key. The keypad device according to the present embodiment shows a case in which a plurality of functions are set to be implemented for one key and different functions are implemented according to the type of user's operation for the same key.

That is, each key of the keypad device according to the present embodiment matches the corresponding function for each type of user's operation, and implements the function of the key corresponding to the type of user's operation detected by the sensing module of the key so that different functions are implemented for each type of user's operation for the key.

For example, if the user can perform three types of operations for each key provided in the keypad device: ‘operation 1’, ‘operation 2’, and ‘operation 3’, and the functions that the first key of the keypad device can be implemented are set to ‘function 1’, ‘function 2’, and ‘function 3’, and the sensing module provided in the first key detects each of the above three types of operations, the keypad device according to the present embodiment can implement ‘function 1’ when detecting ‘operation 1’, ‘function 2’ when detecting ‘operation 2’, and ‘function 3’ when detecting ‘operation 3’ for the first key.

This is shown in more detail in the flowchart of FIG. 8.

The above operation 1, operation 2, and operation 3 can be set as, for example, ‘close’, ‘contact’, and ‘press’ of the golf club head, respectively, and the above-described function 1, function 2, and function 3 for the first key can be set as, for example, ‘voice guidance of wind direction information’, ‘tee-up of a golf ball’, and ‘mulligan’, respectively.

As shown in FIG. 8, when the user's operation for the first key occurs (S100), the controller determines whether operation 1, operation 2, or operation 3 is detected by the sensing module of the first key.

When the sensing module of the first key detects operation 1 (e.g., ‘close’ of the club head to the first key) (S100), the controller determines whether the sensing module detects operation 2 (e.g., ‘contact’ of the club head to the first key) within a preset time (S112), and when operation 2 is not detected, the controller determines that the user's operation is ‘operation l’ and implements function 1 of the first key corresponding thereto (S114).

If operation 1, operation 2, and operation 3 may be matched with the above-described ‘close’, ‘contact’, and ‘press’, respectively, operation 1(close) precedes operation 2(contact), operation 2(contact) precedes operation 3(press). Accordingly, when the sensing module detects ‘operation 1’, the user's operation cannot be immediately determined as ‘operation 1’, and it is necessary to determine whether ‘operation 1’ detected by the sensing module is a preceding operation of ‘operation 2’.

Therefore, when the sensing module detects operation 1 in step S110, it is determined whether operation 2 is additionally detected within a preset time as in step S112, and when operation 2 is not detected, operation 1 detected in step S110 is determined as a true user's operation and function 1 corresponding to operation 1 can be implemented accordingly.

Meanwhile, when operation 2 is detected within a preset time in step S112, the process of the case where the sensing module detects the operation 2 in step S120 is followed.

When the sensing module detects operation 2 (e.g., ‘contact’ of the club head with respect to the first key) (S120), the controller determines whether the sensing module detects operation 3 (e.g., ‘press’ of the club head with respect to the first key) within a preset time (S122), and when operation 3 is not detected, the controller determines that the user's operation is ‘operation 2’ and implements function 2 of the first key corresponding to operation 2 (S124).

If the operation 3 is detected within the preset time in step S122, the process of the case where the sensing module detects the operation 3 in step S130 is followed.

When the sensing module detects operation 3 (e.g., ‘press’ of the club head on the first key) (S130), if there is no other kind of operation that follows, the controller may determine that the user's operation is operation 3, thereby implementing function 3 of the first key corresponding to operation 3 (S134).

In this way, each key of the keypad device according to the present embodiment matches the corresponding function for each type of user's operation, by implementing a function corresponding to the type of operation detected by the sensing module of the key operated by the user, different functions may be implemented for each type of user's operation for one key.

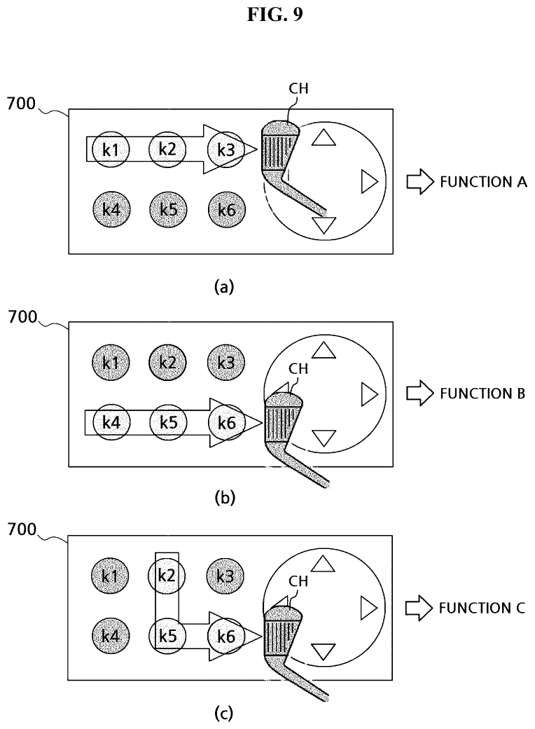

Meanwhile, the keypad device used in the virtual golf simulation apparatus according to another embodiment of the present invention will be described with reference to FIG. 9.

The keypad device according to the present embodiment may include a plurality of keys classified according to functions provided by the virtual golf simulation apparatus, a sensing module provided for each key to detect an operation by a user's body part or golf club, and a controller for generating a preset function according to the order of user's operation for two or more of the plurality of keys.

For example, as shown in FIG. 9(a), the keypad device 700 may have keys of k1 to k6, and the controller may set to execute the A function for the key combination and continuous operation sequence of k1→k2→k3, the B function for the key combination and continuous operation sequence of k4→k5→k6, and the C function for the key combination and continuous operation sequence of k2→k5→k6.

Wherein the above-described A function, B function and C function are different one another, and for example, A function can be set as a ‘mulligan’, B function as a ‘terrain preview’, and C function as a ‘golf ball tee-up’.

The keypad device according to the present embodiment may detect at least one or more of proximity, contact, and pressing by a user's body part or a golf club as an operation on the key. In particular, in the case of proximity or contact by the club head, the function of the desired key can be implemented with continuous contact of a plurality of key combinations quite conveniently and simply.

That is, the controller may detect an operation order for a key combination according to a gesture of the golf club head by the proximity or contact so that a preset function according to the gesture is implemented.

For example, as shown in FIG. 9(a), if the user makes a gesture (e.g., a dragging gesture in a straight line) of dragging the k2 and k3 keys sequentially after the clubhead CH is close to or in contact with the k1 key, the controller may recognize that continuous operations have been performed in the order of the key combination of k1→k2→k3 and implement a preset A function accordingly.

In addition, as shown in FIG. 9(b), if the user makes a gesture (e.g., a dragging gesture in a straight line) of dragging the k5 and k6 keys sequentially after the clubhead CH is close to or in contact with the k4 key, the controller may recognize that the continuous operations have been performed in the order of the key combination of k4→k5→k6 and can implement a preset B function accordingly.

In addition, as shown in FIG. 9(c), if the user makes a gesture of sequentially dragging the k5 and k6 keys (e.g., dragging the k5 and k6 keys in the form of “ [symbol] ”) after the clubhead CH is close to or in contact with the k2 key, the controller may recognize that the continuous operations have been performed in the order of the key combination of k2→k5→k6 and implement a preset C function accordingly.

In addition to the examples shown in FIG. 9, various key functions may be implemented according to the order of a plurality of key combinations and continuous operations.

In this way, in addition to the function assigned to each of the keys, various functions may be implemented through the keypad device despite the limited number of keys provided by the keypad device by allowing the functions of various keys to be implemented according to the order of multiple key combinations and continuous operations.

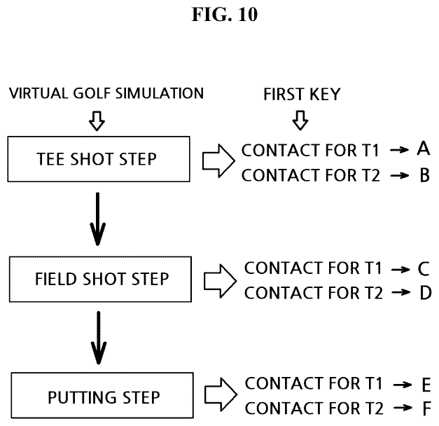

Meanwhile, the virtual golf simulation apparatus according to another embodiment of the present invention will be described with reference to FIG. 10.

The virtual golf simulation apparatus, such as the screen golf system, implements a virtual golf course as an image on the screen for the screen golf, and as the user takes a golf shot on the swing stage, the simulator implements a simulation image in which a virtual ball moves on the virtual golf course image based on sensing information about the movement of at least one of the golf ball and the golf club.

The golf play on the virtual golf course proceeds in the same way as the golf play on the actual golf course, and may be divided into a plurality of step including a tee shot step, a field shot step, and a putting step.

The virtual golf simulation apparatus according to the present embodiment may be configured to change functions according to an operation maintenance time in the keypad device for each step of the virtual golf simulation on the virtual golf course. Accordingly, the virtual golf simulation apparatus according to the present embodiment may selectively activate functions of the keypad device that may be used only in the progress of the virtual golf simulation.

In the present embodiment, the keypad device may be configured as shown in FIG. 6(a). As shown in FIG. 10, depending on the progress of the virtual golf simulation, the functions that may be operated by the first key of the keypad device may be A function and the B function, C function and D function, or E function and F function.

At each progress step of the virtual golf simulation, there are functions that are used only at that step.

For example, in the tee shot step, it may be possible to manipulate a function of increasing the height of the tee or a function of lowering the height of the tee. In the putting step, it may be possible to manipulate a green lie view function or a putting guide displaying function. As described above, there are functions used only in a specific step at each progressing step of the virtual golf simulation.

In the keypad device of the virtual golf simulation apparatus according to the present embodiment, even with the same key, the function implemented by manipulation of the corresponding key may be changed according to the progress of the virtual golf simulation performed by the simulator.

For example, as shown in FIG. 10, when the controller of the keypad device recognizes that the clubhead is in the tee shot step of the virtual golf simulation, ‘A function’ may be implemented if the clubhead is kept in contact with the first key of the keypad device for T1 time, and ‘B function’ may be implemented if the clubhead is kept in contact with the first key of the keypad device for T2 time. When the controller of the keypad device recognizes that the clubhead is in the field shot step of the virtual golf simulation, ‘C function’ may be implemented if the clubhead is kept in contact with the first key of the keypad device for T1 time, and ‘D function’ may be implemented if the clubhead is kept in contact with the first key of the keypad device for T2 time. When the controller of the keypad device recognizes that the clubhead is in the putting step of the virtual golf simulation, ‘E function’ may be implemented if the clubhead is kept in contact with the first key of the keypad device for T1 time, and ‘F function’ may be implemented if the clubhead is kept in contact with the first key of the keypad device for T2 time. Wherein each of the functions A to F as described above may be different functions.

As described above, the present invention has the advantage of implementing various functions despite the limited number of keys provided by the keypad device in order to solve the problem of the conventional technology that there are many and various functions that can be implemented by user's operations in the virtual golf simulation process.

### INDUSTRIAL APPLICABILITY

The virtual golf simulation apparatus and the keypad device according to the present invention can be used in industrial fields related to ball sports performed using a ball such as golf and industrial fields related to allowing users to practice or enjoy ball sports in a virtual environment such as so-called a screen golf, which allows users to enjoy golf play based on virtual golf simulations.

1. A keypad device used in a virtual golf simulation apparatus comprising:
a pad body providing a plurality of key operators each of which detects manipulation by a user's body part or a golf club and cause a haptic reaction;
a pad cover couplable to an upper end of the pad body and providing a plurality of key indicators each of which is provided at a position corresponding to each of the key operators and displays a function of a corresponding key; and
a controller that controls the key operator to generate a haptic response according to the user's operation with respect to the corresponding key indicator, and implements a function corresponding to the operated key indicator.

2. The keypad device according to claim 1, wherein each of the key operators includes:
a sensing module configured to detect at least one of the proximity, contact, and pressing of the user's body part or golf club as the operation; and
a vibration module that generates vibration for the haptic reaction as the sensing module detects the operation.

3. The keypad device according to claim 2, wherein each of the key operators includes a light emitting module that allows light to be emitted through each of the key indicators as the sensing module detects the operation.

4. The keypad device according to claim 2, wherein the sensing module includes a metal detection sensor that detects a metal material and transmits a sensing value according to a distance from the metal material to the controller, and the controller is configured to recognize the operation as the golf club head is close to or in contact with the key indicator within a predetermined distance according to the sensing value of the metal detection sensor.

5. The keypad device according to claim 2, wherein the sensing module includes a pressure sensor that transmits a sensing value according to the pressure of an object to the controller, and the controller is configured to recognize that the user's body part contacts or presses on the key indicator according to the sensing value of the pressure sensor as the operation.

6. The keypad device according to claim 2, wherein the sensing module includes a metal detection sensor that detects a metal material and transmits a sensing value according to a distance from the metal material to the controller, and a pressure sensor that transmits a sensing value according to the pressure of a non-metal object to the controller.

7. The keypad device according to claim 1, wherein the controller is configured to detect the operation of the key as the user operates on the corresponding key indicator, to calculate the time for the operation to be maintained, and to generate different preset key functions according to the calculated operation maintenance time.

8. A keypad device used in a virtual golf simulation apparatus comprising:
a plurality of keys classified according to functions provided by the virtual golf simulation apparatus;
a sensing module provided for each of the keys to detect operation by a user's body part or a golf club; and
a controller that recognizes a sensing value of the sensing module as the user's operation on the key, maintains the recognition of the sensing value of the sensing module until the user's operation is released, and generates a preset key function based on the maintained time.

9. The keypad device according to claim 8, wherein the sensing module is configured to include one or more sensors for detecting at least one of the proximity, contact, and pressing of the user's body part or golf club as the user's operation.

10. The keypad device according to claim 8, wherein the sensing module is configured to include a metal detection sensor that transmits a sensing value according to a distance from a metal material to the controller to detect that the golf club head is close to or in contact with the key indicator within a predetermined distance, and the controller is configured to maintain recognition of the sensing value of the metal detection sensor until the proximity or contact state of the golf club head is released, and to implement different key functions according to the range of the maintenance time.

11. The keypad device according to claim 8, wherein the sensing module is configured to include a pressure sensor that transmits a sensing value according to the pressure of an object to the controller to detect that the user's body part contacts or presses the key indicator, and the controller is configured to maintain recognition of the sensing value of the pressure sensor until the state of contact or pressing by the user's body part is released, and to implement different key functions according to the range of the maintenance time.

12. The keypad device according to claim 1, wherein the controller generates a preset function according to the order of the operation for two or more key combinations of the plurality of the keys.

13. The keypad device according to claim 12, wherein the sensing module is configured to detect the proximity or contact of the golf club head, and the controller is configured to detect an operation order for the key combination according to gesture of the golf club head by the proximity or contact to generate a preset function according to the gesture.

14. The keypad device according to claim 1, wherein each of the key operators includes a sensing module configured to detect at least one of the proximity, contact, and pressing of the user's body part or golf club as the operation; and
the controller sets at least one key of the plurality of keys to implement a plurality of functions, recognizes the type of the user's operation detected by the sensing module, matches the corresponding function among the plurality of functions of the key for each type of the user's operation, and implements different functions for each type of the user's operation for the key.

15. The keypad device according to claim 14, wherein when the user's operation is detected for the key by the sensing module, the controller is configured to control to implement a function of the corresponding key corresponding to the detected user's operation when no other kind of subsequent operation for the key is detected for a preset time.

16. A virtual golf simulation apparatus comprising:
a simulator that implements a simulation image in which a virtual ball moves on a virtual golf course image based on sensing information on the movement of at least one of a golf ball and a golf club as a user takes a golf shot on a swing stage;
an image output device that outputs the virtual golf course image and simulation image implemented by the simulator; and
a keypad device that is provided on or adjacent to the swing stage so that the user operate to implement functions provided by the simulator,
wherein the keypad device includes:
a plurality of keys classified according to the functions provided by the simulator,
a sensing module provided for each of the keys to detect an operation by a user's body part or golf club, and
a controller that generates a preset function of the simulator based on an operation maintenance time until the operation on the key is performed and the operation on the key is released.

17. The virtual golf simulation apparatus according to claim 16, wherein at least on function generated according to the operation maintenance time in the keypad device is changed according to the progress of the virtual golf simulation on the virtual golf course.
